(19) United States
(12) Patent Application Publication
(10) Pub. No.: US 2007/0005508 A1
(43) Pub. Date: Jan. 4, 2007

(54) System and method for verifying personal identity on internet

(75) Inventor: Kuan Yu Chiang, Taipei (TW)

Correspondence Address: BIRCH STEWART KOLASCH & BIRCH, PO BOX 747, FALLS CHURCH, VA, 22040-0747, US

(73) Assignee: Ite2 TECHNOLOGY INC.

(21) Appl. No.: 11/455,729

(22) Filed: Jun. 20, 2006

(30) Foreign Application Priority Data
Jun. 21, 2005 (TW) 094120541

(51) Int. Cl. G06Q 99/00; H04L 9/00; H04K 1/00

(52) U.S. Cl. 705/64

(57) ABSTRACT

A method and system for verifying personal identity on internet to verify personal identity of the user in internet trades, wherein the internet trades are undergone with credit card, other finance token, or saving account. The system for verifying personal identity on internet comprises a finance agency authorization end, a user end, and an internet trade platform. The user end has a first user interface and a second user interface. The first user interface is connected with the finance agency authorization end through a first communication path. The second user interface is connected with the finance agency authorization end through a second communication path. The method for verifying personal identity on internet comprises transferring a verifying code to a user through a communication path and checking the verifying code entered by the user from another communication path.

### BACKGROUND OF THE INVENTION

1. Field of the Invention

The present invention relates generally to a method and a system for verifying personal identity on internet; particularly, the present invention relates to a method and system for verifying personal identity in internet trades.

2. Description of the Prior Art

Following the well-developed internet technology and the wild use of internet, trades on internet becomes one of the most important ways of product distribution. Different to the traditional “face to face” trading, the buyers and sellers in internet trades undergo their trades through the trade platform constructed on the internet. Since it is difficult to verify the identity of a buyer, the buyer may use counterfeit credit card of account data to process the business and therefore cause sellers’ damages.

The most usual way of trading on the internet is that the buyer (card holder) makes a trading request by entering the buyer's credit card or account data on the web page constructed by the seller or merchant. The seller transfers the received data through an acquiring bank to a corresponding finance agency that issues the credit card. The finance agency verifies the received data and checks the conditions of the credit card or account used to request the trade, such as the credit limit or available credit, to determine either authorize the trade or not. If the credit checking process of the finance agency passes, the finance agency then authorizes the trade by giving an authorization code. If the credit checking process of the finance agency fails, the finance agency will inform the seller and reject the trade request.

Since the seller is not available to instantly check the identity of the buyer, such as comparing the signature or checking the identity card, when internet trades are taking place the circumstance that some buyers willfully misapplying other's credit card, account, or other finance token may occur. To avoid this circumstance, some finance agency gives an account or a password for use only in internet trades to their credit card holders at the same time when issuing them the credit cards. The holders have to enter the account or the password to identify themselves when undergoing internet trades.

Another usual approach is simultaneously sending messages to the mobile phones of the credit card holders when the finance agencies authorize the trade requests on internet. The mobile phone numbers are registered when the credit card holders applied for their credit cards. This approach makes sure the credit card holder and the user requesting trade on internet are the same. However, the loss of the sellers on internet still may occur since this approach is not able to terminate the internet trade instantly.

### SUMMARY OF THE INVENTION

It is an object of the present invention to provide a method and a system for verifying personal identity on internet to verify personal identity of the user in internet trades, wherein the internet trades are undergone with credit card, other finance token, or saving account.

It is another object of the present invention to provide a method and a system for verifying personal identity on internet to reduce the possibility of the willfully misapplying of credit card or other finance token.

It is a further object of the present invention to provide a method and a system for verifying personal identity on internet to increase the reliability in internet trades.

The system for verifying personal identity on internet comprises a finance agency authorization end, a user end, and an internet trade platform. The finance agency authorization end has a reversible code generating module and a storage device. The user end has a first user interface and a second user interface. The first user interface is connected with the finance agency authorization end through a first communication path. The second user interface is connected with the finance agency authorization end through a second communication path. Besides, the internet trade platform is also connected with the second user interface through the second communication path. Moreover, the internet trade platform is connected with the finance agency authorization end through the second communication path or other communication path like telecommunication lines.

When the user end applies the trade request on the internet trade platform through the second communication path, the finance agency authorization end generates a first verifying code and a trade approval data. The generated trade approval data is stored in the storage device. The storage device further stores the user's opening account basic data.

The generated first verifying code is transferred to the internet trade platform through the second communication path according to the internet address of the trade approval data. Also, the first verifying code is transferred to the reversible code generating module, wherein the reversible code generating module is applied to generate a second verifying code corresponding to the first verifying code. The second verifying code is transferred to the first user interface through the first communication path.

The user enters an input second verifying code through the second user interface according to the received second verifying code. The input second verifying code is transferred to the finance agency authorization end through the second communication path. The reversible code generating module is applied reversely to generate an input first verifying code corresponding to the input second verifying code. The input first verifying code is transferred to the internet trade platform to be compared with the first verifying code. The trade checking result includes a trade permission if the user's identity is judged doubtless when the first verifying code is identical to the input first verifying code. The trade checking result includes a trade rejection if the user's identity is judged doubtful when the first verifying code is not identical to the input first verifying code.

### BRIEF DESCRIPTION OF THE DRAWINGS

FIG. 1 is an embodiment of the system of the present invention for verifying personal identity on internet.

FIG. 2 is another embodiment of the system of the present invention for verifying personal identity on internet.

FIG. 3a is a flowchart of an embodiment of the system of the present invention for verifying personal identity on internet.

FIG. 3b is a flowchart of another embodiment of the system of the present invention for verifying personal identity on internet.

FIG. 4 is a flowchart of a further embodiment of the system of the present invention for verifying personal identity on internet.

### DETAILED DESCRIPTION OF THE PREFERRED EMBODIMENT

The present invention provides a method and a system for verifying personal identity in internet trades, wherein the internet trades are undergone with credit card, other finance token, or saving account. The internet, including an internet network and a communication network, connects the user and the seller/merchant who builds up the internet trade platform.

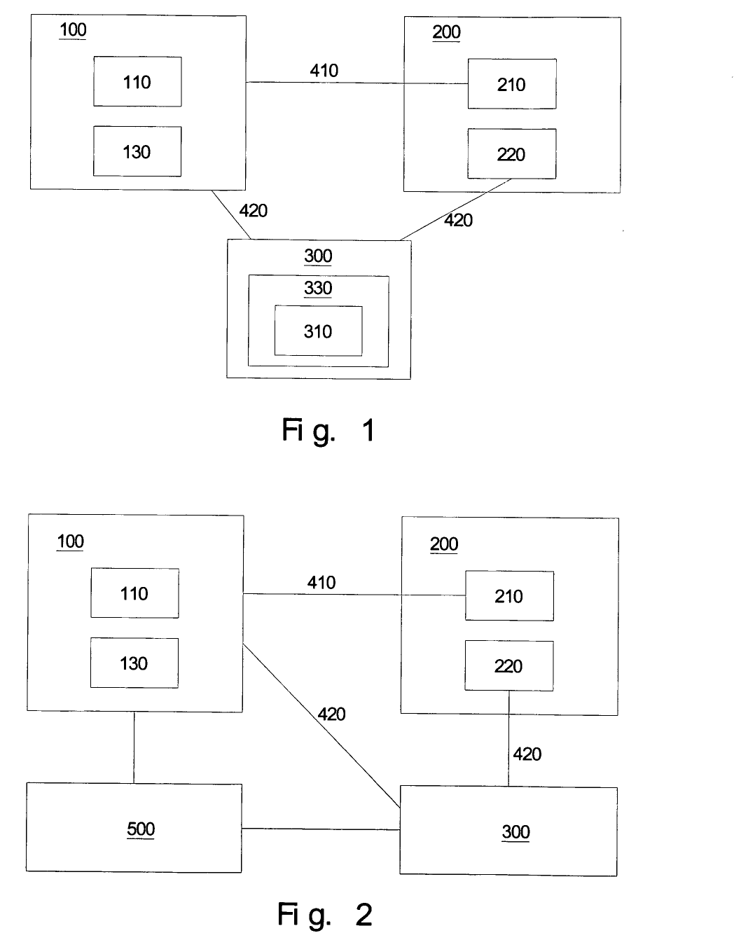

The system for verifying personal identity on internet of the present invention comprises a finance agency authorization end 100, a user end 200, and an internet trade platform 300. With reference to FIG. 1, the user end 200 has a first user interface 210 and a second user interface 220. In a preferred embodiment, the first user interface 210 inlcudes a mobile phone. In another embodiment, however, the first user interface 210 may be an interface such as a communication module contained PDA, a laptop computer, a personal computer, or an E-mail communication, as long as the interface is available to accept the information from outside. Besides, in a preferred embodiment, the second user interface 220 includes a personal computer. In another embodiment, however, the second user interface 220 may be an interface available to be connected with the internet or other communication path, such as a laptop computer.

The first user interface 210 is connected with the finance agency authorization end 100 through a first communication path 410. The second user interface 220 is connected with the finance agency authorization end 100 through a second communication path 420. The internet trade platform 300 is also connected with the second user interface 220 through the second communication path 420. The internet trade platform 300 is connected with the finance agency authorization end 100 through the second communication path 420 or other communication path like telecommunication lines. In a preferred embodiment, the first communication path 410 includes a mobile phone message communication. In another embodiment, however, the first communication path 410 includes a voice phone communication, an E-mail communication or other path which is available to transfer information. In a preferred embodiment, the second communication path 420 includes an internet network. In another embodiment, however, the second communication path 420 includes other communication network which is identical to other communication agreement.

With reference to FIG. 1, the finance agency authorization end 100 has a reversible code generating module 110 and a storage device 130. In a preferred embodiment, the finance agency authorization end 100 includes a server device. The reversible code generating module 110 is applied in a processor of the server device. An output value is obtained by entering an input value into the reversible code generating module 110. And the original input vale is obtained by entering the output value into the reversible code generating module 110 reversely. In a preferred embodiment, the reversible code generating module 110 includes calculating method applying a reversible calculation, an equation, a corresponding transform table, or a random values table.

When the user end 200 applies the trade request on the internet trade platform 300 through the second communication path 420, the finance agency authorization end 100 generates a first verifying code and a trade approval data according to the trade request. Particularly, the finance agency authorization end 100 checks the account information or the credit condition of the user according to the trade request to generate the first verifying code and the trade approval data.

The generated trade approval data is stored in the storage device 130 of the finance agency authorization end 100. In a preferred embodiment, the trade approval data contains the internet address of the user end 200 and the internet trade platform 300. The storage device 130 further stores the user's opening account basic data. In a preferred embodiment, the user's opening account basic data is the data provided by the user when the user applied for the credit card, other finance token, or saving account. Wherein the user's opening account basic data includes the data of the first user interface 210, like a mobile phone number, an E-

mail address, and etc.

In a preferred embodiment, the first verifying code is the credit card authorization code. In another embodiment, however, the first verifying code could be the authorization code of other finance token or credit trading. The generated first verifying code is transferred to the internet trade platform 300 through the second communication path 420 according to the internet address of the trade approval data. Also, the first verifying code is transferred to the reversible code generating module 110, wherein the reversible code generating module 110 is applied to generate a second verifying code corresponding to the first verifying code. The second verifying code is transferred to the first user interface 210 through the first communication path 410. The user enters an input second verifying code through the second user interface 220 according to the received second verifying code. The input second verifying code is transferred to the finance agency authorization end 100 through the second communication path 420. The reversible code generating module 110 is applied reversely to generate an input first verifying code corresponding to the input second verifying code. The input first verifying code is transferred to the internet trade platform 300 instantly.

With reference to FIG. 1, the internet trade platform 300 further comprises a verifying code comparing module 310. Wherein the verifying code comparing module 310 compares the input first verifying code with the first verifying code received from the finance agency authorization end 100 to generate a trade checking result. In a preferred embodiment, the internet trade platform 300 includes a server 330. The verifying code comparing module 310 is the program running in the server 330. The trade checking result includes a trade permission if the user's identity is judged doubtless when the first verifying code is identical to the input first verifying code. The trade checking result includes a trade rejection if the user's identity is judged doubtful when the first verifying code is not identical to the input first verifying code.

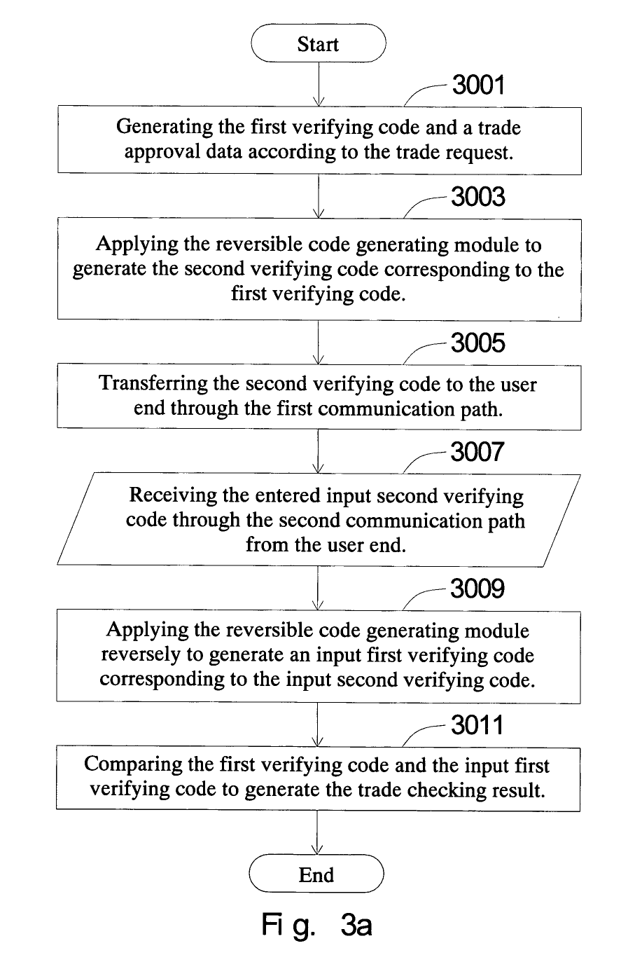

FIG. 2 refers to another embodiment of the present invention. With reference to FIG. 2, the system for using with the method for verifying personal identity on internet of the present invention further comprises an acquiring bank end 500. The acquiring bank end 500 is connected with the finance agency authorization end 100 and the internet trade platform 300 respectively. In a preferred embodiment, the acquiring bank end 500 is connected with the finance agency authorization end 100 and the internet trade platform 300 with telecommunication lines respectively. In another embodiment, however, an internet net work or other data transferable path could be used. When the user end 200 applies the trade request on the internet trade platform 300 through the second communication path 420, the trade request is transferred from the internet trade platform 300 to the acquiring bank end 500 instantly. The acquiring bank end 500 judges the finance agency authorization end 100 corresponding to the trade request according to the information, like a credit card number or other identifying data, of the trade request and transfers the trade request to the judged finance agency authorization end 100.

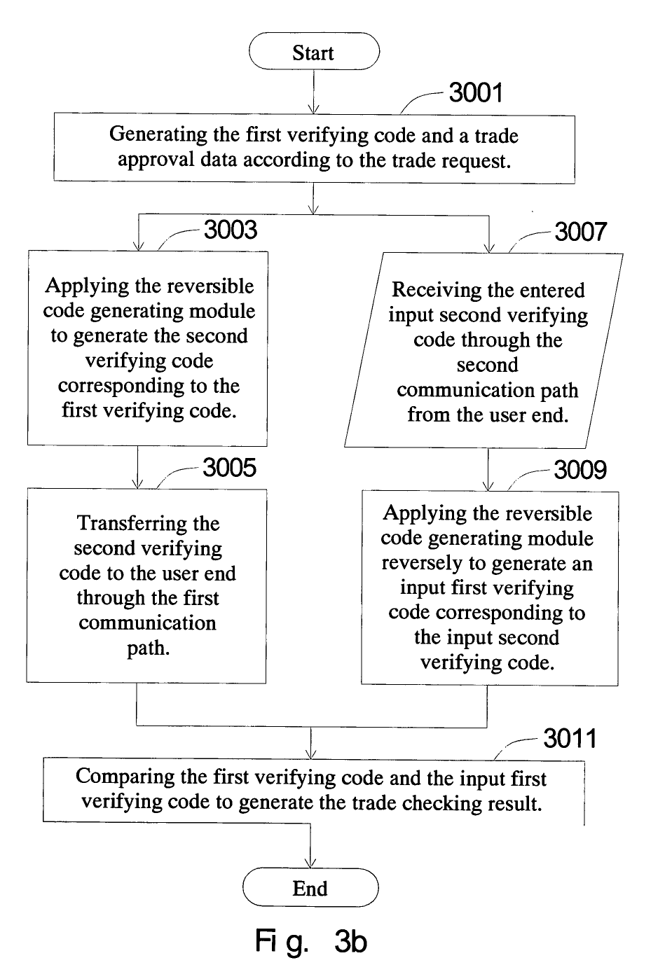

FIG. 3a is a flowchart of an embodiment of the system for verifying personal identity on internet of the present invention. Step 3001 includes generating the first verifying code and a trade approval data according to the trade request. As mentioned above, in a preferred embodiment, the first verifying code is the credit card authorization code. The trade approval data contains the internet address of the user end 200. In another embodiment, however, the first verifying code could be the authorization code of other finance token or credit trading.

Besides, in a preferred embodiment, the trade request is applied on the internet trade plat form 300 from the user end 200 through the second communication path 420. The trade request is transferred to the finance agency authorization end 100 instantly. In a preferred embodiment, the internet trade platform 300 transfers the trade request from the acquiring bank end 500 to the finance agency authorization end 100. In another embodiment, however, the internet trade platform 300 could transfers the trade request directly to the finance agency authorization end 100. Besides, the second communication path 420 includes an internet network. In another embodiment, however, the second communication path 420 includes other communication network which is identical to other communication agreement.

Step 3003 includes applying the reversible code generating module to generate the second verifying code corresponding to the first verifying code, i.e. generating the second verifying code by entering the first verifying code to the reversible code generating module to proceed a calculation. As mentioned above, an output value is obtained by entering an input value into the reversible code generating module 110. And the original input vale is obtained by entering the output value into the reversible code generating module 110 reversely. In a preferred embodiment, the reversible code generating module 110 includes calculating method applying a reversible calculation, an equation, a corresponding transform table, or a random values table.

Step 3005 includes transferring the second verifying code to the user end 200 through the first communication path 410. In a preferred embodiment, the second verifying code is transferred from the finance agency end 100 to the user end 200 through the first communication path 410, wherein the first communication path 410 includes a mobile phone message communication. In another embodiment, however, the first communication path 410 includes a voice phone communication, an E-mail communication or other path which is available to transfer information.

Besides, in a preferred embodiment, the finance agency authorization end 100 chooses and selects the appropriate first communication path 410 according to the stored user's opening account basic data. In this embodiment, the stored user's opening account basic data is the data provided by the user when the user applied for the credit card, other finance token, or saving account. Wherein the user's opening account basic data includes the data of the first user interface 210, such as a mobile phone number, an E-mail address, and etc.

Step 3007 includes receiving the entered input second verifying code through the second communication path 420 from the user end 200. In this embodiment, the user enters the input second verifying code through the second user interface 220 according to the received second verifying code. The input second verifying code is transferred to the finance agency authorization end 100 through the second communication path 420.

Step 3009 includes applying the reversible code generating module 110 reversely to generate an input first verifying code corresponding to the input second verifying code. Step 3011 includes comparing the first verifying code and the input first verifying code to generate the trade checking result. In this embodiment, the trade checking result includes a trade permission if the user's identity is judged doubtless when the first verifying code is identical to the input first verifying code. The trade checking result includes a trade rejection if the user's identity is judged doubtful when the first verifying code is not identical to the input first verifying code.

It is notable the steps in the embodiment shown in FIG. 3a could be arranged in different order. FIG. 3b shows the embodiment shown in FIG. 3a with steps in different order after arranged.

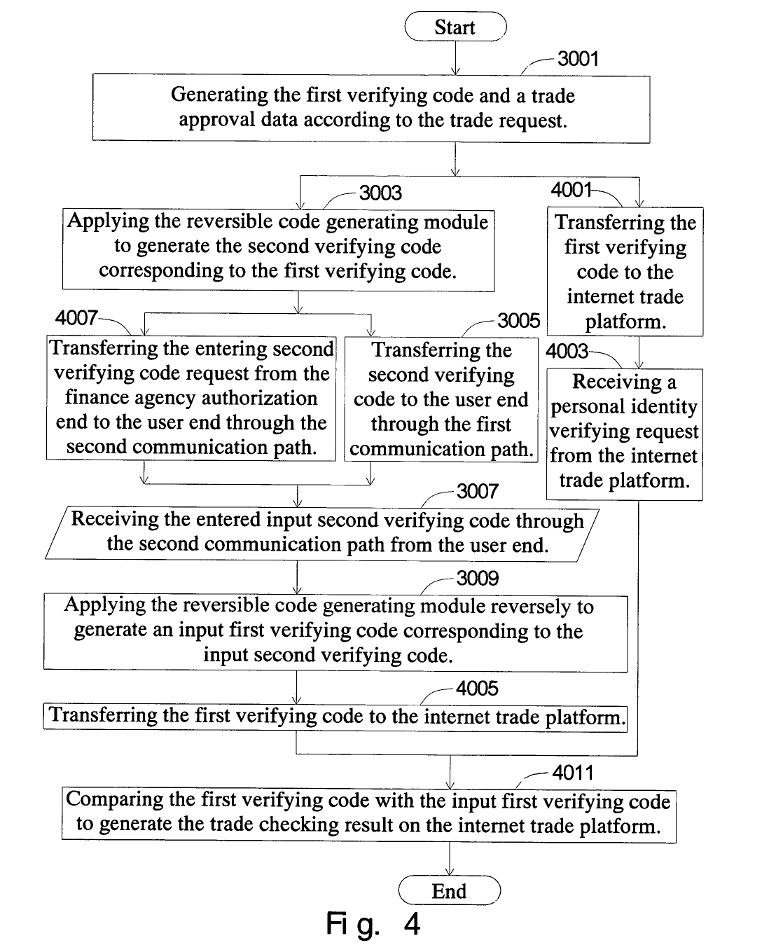

FIG. 4 is a flowchart of another embodiment of the system for verifying personal identity on internet of the present invention. The embodiment shown in FIG. 4 further comprises step 4001, transferring the first verifying code to the internet trade platform 300. In a preferred embodiment, the first verifying code is transferred from the finance agency authorization end 100 to the internet trade platform 300 through the second communication path 420. In another embodiment, however, the first verifying code could be transferred through other communication path like a telephone line.

Step 4003 includes receiving a receiving a personal identity verifying request from the internet trade platform 300. In this embodiment, after receiving the first verifying code transferred from the finance agency authorization end 100, the internet trade platform 300 transfers the personal identity verifying request to the finance agency authorization end 100 instantly. The finance agency authorization end 100 proceeds all the following steps shown in FIG. 4 according to the personal identity verifying request.

Step 4005 includes transferring the first verifying code to the internet trade platform 300. In a preferred embodiment, the first verifying code is transferred from the finance agency authorization end 100 to the internet trade platform 300 through the second communication path 420. Besides, the comparing step 4011 includes comparing the first verifying code with the input first verifying code to generate the trade checking result on the internet trade platform 300.

Step 4007 includes transferring the entering second verifying code request from the finance agency authorization end 100 to the user end 200 through the second communication path 402. In a preferred embodiment, the finance agency authorization end 100 transfers the entering second verifying code request to the user end 200 according to the user end internet address of the trade approval data. Besides, the entering second verifying code request is shown on the second user interface, like monitors of computer or PDA.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method for verifying personal identity on internet comprising:
generating a first verifying code and a trade approval data according to a trade request;
applying a reversible code generating module to generate a second verifying code corresponding to said first verifying code;
transferring said second verifying code to an user end through a first communication path;
receiving an entered input second verifying code through a second communication path from said user end;
applying said reversible code generating module reversely to generate an input first verifying code corresponding to said input second verifying code; and
comparing said first verifying code and said input first verifying code to generate a trade checking result.

2. The method for verifying personal identity on internet of claim 1 further comprising:
transferring said first verifying code to a internet trade platform, and
transferring said input first verifying code to said internet trade platform.

3. The method for verifying personal identity on internet of claim 2, wherein said comparing step includes comparing said first verifying code with said input first verifying code to generate a trade checking result on said internet trade platform.

4. The method for verifying personal identity on internet of claim 2 further comprising receiving a personal identity verifying request from said internet trade platform.

5. The method for verifying personal identity on internet of claim 1, wherein the step of transferring said second verifying code to a user end includes transferring said second verifying code from a finance agency authorization end to said user end through said first communication path.

6. The method for verifying personal identity on internet of claim 5, wherein said finance agency authorization end selects said first communication path according to a user's opening account basic data.

7. The method for verifying personal identity on internet of claim 1, wherein said receiving an input second verifying code step includes receiving said entered input second verifying code from said user end through a second communication path from said user end to a finance agency authorization end.

8. The method for verifying personal identity on internet of claim 1 further comprising transferring an input second verifying code from a finance agency authorization end to said user end through said second communication path.

9. The method for verifying personal identity on internet of claim 8, wherein said finance agency authorization end transfers an input second verifying code request to said user end through said second communication path according to a user end address of said trade approval data.

10. The method for verifying personal identity on internet of claim 1, wherein said trade checking result includes a trade permission when said first verifying code is identical to said input first verifying code.

11. The method for verifying personal identity on internet of claim 1, wherein said first communication path is selected from the group of a mobile phone message communication, an E-mail communication, and a voice phone communication.

12. The method for verifying personal identity on internet of claim 1, wherein said second communication path includes an internet.

13. The method for verifying personal identity on internet of claim 1, wherein said first verifying code includes a credit card authorization code.

14. A method for verifying personal identity on internet comprising:
transferring a first verifying code from a finance agency authorization end to a internet trade platform according to a trade approval data.
applying a reversible code generating module to generate a second verifying code corresponding to said first verifying code;
transferring said second verifying code from said finance agency authorization end to an user end through a first communication path from;
receiving an entered input second verifying code from said user end to said finance agency authorization end through a second communication path;
applying said reversible code generating module reversely to generate an input first verifying code corresponding to said input second verifying code;
transferring said input first verifying code to said internet trade platform; and
comparing said first verifying code and said input first verifying code on said internet trade platform to generate a trade checking result.

15. The method for verifying personal identity on internet of claim 14 further comprising receiving a personal identity verifying request from said internet trade platform to said finance agency authorization end.

16. The method for verifying personal identity on internet of claim 14, wherein said finance agency authorization end selects said first communication path according to a user's opening account basic data.

17. The method for verifying personal identity on internet of claim 14, wherein said finance agency authorization end transfers an entering second verifying code request to said user end through said second communication path according to a user end address of said trade approval data.

18. The method for verifying personal identity on internet of claim 14, wherein said trade checking result includes a trade permission when said first verifying code is identical to said input first verifying code.

19. The method for verifying personal identity on internet of claim 14, wherein said first communication path is selected from the group of a mobile phone message communication, an E-mail communication, and a voice phone communication.

20. The method for verifying personal identity on internet of claim 1, wherein said second communication path includes an internet.

21. The method for verifying personal identity on internet of claim 1, wherein said first verifying code includes a credit card authorization code.

22. A system for verifying personal identity on internet, comprising:
a finance agency authorization end having a reversible code generating module and a storage device, wherein said storage device stores a trade approval data and a user's opening account basic data;
a user end having a first user interface and a second user interface, wherein said first user interface and said second user interface are connected with said finance agency authorization end through a first communication path and said second communication path respectively; and
an internet trade platform having a verifying code comparing module, wherein said internet trade platform is connected with said finance agency authorization end through said second user interface of said second communication path.

23. The system of claim 22 further comprising an acquiring bank end, wherein said acquiring bank end is connected with said finance agency authorization end and said internet trade platform respectively.

24. The system of claim 22, wherein said first communication path includes a mobile phone message communication.

25. The system of claim 22, wherein said second communication path includes an internet.

26. The system of claim 22, wherein said trade approval data includes a user end address.

27. The system of claim 22 further comprising:
a first verifying code being transferred to said internet trade platform, wherein said first verifying code is generated by said finance agency authorization end;
a second verifying code being transferred to said first user end through said first communication path, wherein said second verifying code is generated by applying said reversible code generating module corresponding to said first verifying code;
an input second verifying code being transferred to said finance agency authorization end through said second communication path, wherein said input second verifying code is received by said second user interface; and
an input first verifying code being transferred to said internet trade platform through said second communication path, wherein said input first verifying code is generated by applying said reversible code generating module corresponding to said input second verifying code.

28. The system of claim 27, wherein said first verifying code includes a credit card authorization code.
